(19) United States
(12) Patent Application Publication
(10) Pub. No.: US 2007/0164581 A1
(43) Pub. Date: Jul. 19, 2007

(54) Protection device for motor vehicle

(76) Inventor: Marina Ehrenberger, Esslingen (DE)

Correspondence Address: FLYNN THIEL BOUTELL & TANIS, P.C., 2026 RAMBLING ROAD, KALAMAZOO, MI, 49008-1631, US

(21) Appl. No.: 11/643,240

(22) Filed: Dec. 21, 2006

(30) Foreign Application Priority Data
Jan. 2, 2006 (DE) 102006001029.9

(51) Int. Cl. B60N 3/12

(52) U.S. Cl. 296/37.16

(57) ABSTRACT

1. Protection device for a motor vehicle.

2.1. A protection device for a motor vehicle with a flexible sheetlike structure which is arranged on a winding shaft in a manner such that it can be wound up and unwound between an inoperative position and a protection position, the winding shaft being acted upon by torque in the winding-up direction by means of a winding spring arrangement, the winding-up force of which can be reduced by means of a control mechanism, the control mechanism comprising a spiral counting means and a control finger which is guided in the spiral counting means, is known.

2.2. According to the invention, the control finger is assigned securing means which hold the control finger back in an inner position in the winding-up direction of the sheetlike structure.

2.3. Use for restraint devices in a vehicle interior.

The invention relates to a protection device for a motor vehicle with a flexible sheetlike structure which is arranged on a winding shaft, which is mounted rotatably in a housing, in a manner such that it can be wound up and unwound between a wound-up inoperative position and at least one at least partially extended protection position, the winding shaft being acted upon by torque in the winding-up direction by means of a winding spring arrangement, the winding-up force of which can be reduced by means of a control mechanism, the control mechanism comprising a spiral counting means and a control finger, which is guided in the spiral counting means, is movable radially relative to a winding axis of the winding shaft and is pressed, at least in the unwinding direction, by spring force against a guide web, which has a spiral-shaped profile, of the spiral counting means.

A protection device of this type is known from WO 98/24660 A2. The protection device has a flexible separating net which, in an inoperative position, is wound up on a winding shaft within a cassette housing. In a protection position, the separating net is pulled out from the cassette housing and fitted with its front end region in holders on the roof, so that the separating net is stretched approximately vertically between the cassette housing and a roof lining of the vehicle interior. In order to make it easier for an operator to pull the separating net out from the winding housing and to fit it into the holders on the roof, the restoring force, which acts on the separating net, of a winding spring arrangement within the cassette housing is reduced or neutralized from a defined pull-out distance of the separating net. As a result, an operator can initially pull out the separating net approximately horizontally towards the vehicle rear until the control mechanism for switching off or reducing the restoring force of the winding spring becomes effective. The separating net can subsequently be fitted without great effort into the holders on the roof. As soon as the winding spring arrangement becomes effective again, it rotates the winding shaft back in the winding-up direction. The control or switching mechanism which neutralizes or reduces the effectiveness of the winding spring arrangement is provided with a counting mechanism, with a radially movable and radially spring-loaded counting finger being arranged at the end of the winding shaft. The counting finger engages in a spiral counting means arranged in a stationary manner on the cassette housing, and, as the winding shaft rotates, gradually migrates outward in the spiral counting means. As the winding shaft is being wound up, the counting finger passes after a certain rotational movement into a radially inner spiral winding, so that, upon each revolution during the further winding-up operation, it springs back from the end of the inner turn into the next outer turn. This results in a repetitive clicking noise during the winding-up operation.

It is the object of the invention to provide a protection device of the type mentioned at the beginning, in which the formation of noise during the operation to wind up the sheetlike structure is avoided.

This object is achieved in that the control finger is assigned securing means which hold the control finger back in an inner position in the winding-up direction of the sheetlike structure. As a result, it is avoided, according to the invention, that, as the sheetlike structure is being wound up, the control finger, which serves as the counting finger, after reaching the inner spiral turn strikes back, in the inner end region of the inner spiral turn, due to its spring loading against the next outer spiral turn. On the contrary, the control finger is held in a stable position, so that the spring force acting on the control finger cannot press the control finger against the corresponding guide web of the spiral counting means. The securing means act only in the winding-up direction of the sheetlike structure. In the unwinding direction, they are ineffective or disengaged. A formation of noise in the winding-up direction of the sheetlike structure is effectively avoided by the solution according to the invention. The solution according to the invention is suitable in particular for protection devices in the vehicle interior of a motor vehicle, preferably for separating devices which separate a passenger compartment from a loading compartment. The solution according to the invention is also suitable for sun protection devices, in which a flexible sheetlike structure serving as a sun protection means is provided with a control mechanism which has a spiral counting means and a corresponding control finger.

In a development of the invention, the control finger is guided in a radially movable manner in a radial guide assigned to the winding shaft, and the securing means are designed as mutually corresponding undercuts, which are effective with a form fit, in the region of the radial guide, on the one hand, and in the region of the control finger, on the other hand. As a result, the securing means are designed as mechanically effective profiled latching means. The corresponding undercuts are preferably provided integrally on the radial guide, on the one hand, and in the region of an outer contour of the control finger, on the other hand. This results in a particularly simple and nevertheless functionally reliable refinement.

In a further refinement of the invention, the radial guide is designed in such a manner that the control finger can carry out limited tilting movements about a tilting axis running coaxially or parallel to the winding axis. The tilting axis is preferably realized coaxially with the winding axis. The additional, limited tiltability of the control finger enables the latter preferably to tilt in one direction of rotation of the winding shaft in such a manner that the undercuts of the control finger and the radial guide engage one behind the other and, in this position, secure the position of the control finger against the spring force of the control finger. In the other direction of rotation, the control finger is tilted in the opposite direction, so that the undercuts come free from each other and the corresponding spring loading presses the control finger against the guide web of the spiral counting means.

In a further refinement of the invention, the undercuts of the radial guide and of the control finger are arranged on an individual, common side which is selected in such a manner that the undercuts engage one behind the other in the winding-up direction of the winding shaft and are separated from each other in the unwinding direction. This ensures, by simple means, that the control finger is secured in position in one direction of rotation and can run along the spiral counting means in the other direction of rotation.

In a further refinement of the invention, the radial guide is constricted level with the winding axis and expands radially outward to opposite sides in the manner of a funnel. As a result, the desired tiltability of the control finger is achieved by simple means.

Further advantages and features of the invention emerge from the claims and from the description below of a preferred exemplary embodiment of the invention, which is illustrated with reference to the drawings.

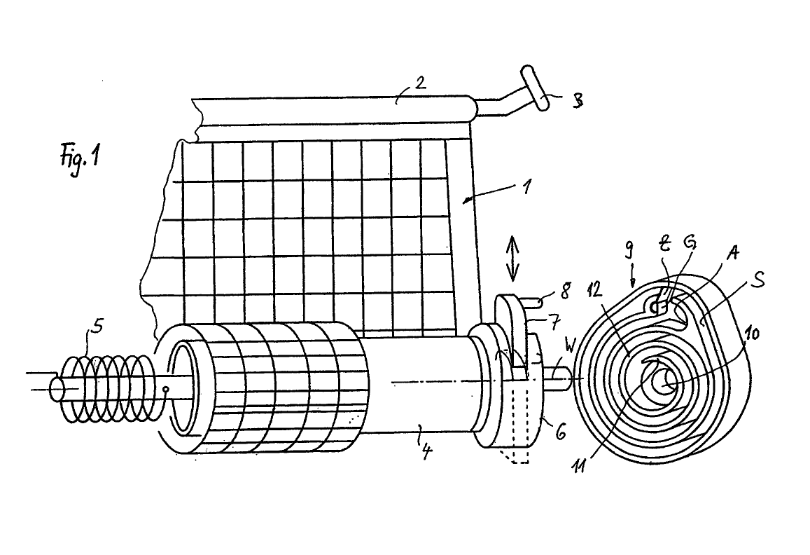

FIG. 1 shows, in a perspective, schematized illustration, an excerpt of an embodiment of a protection device according to the invention,

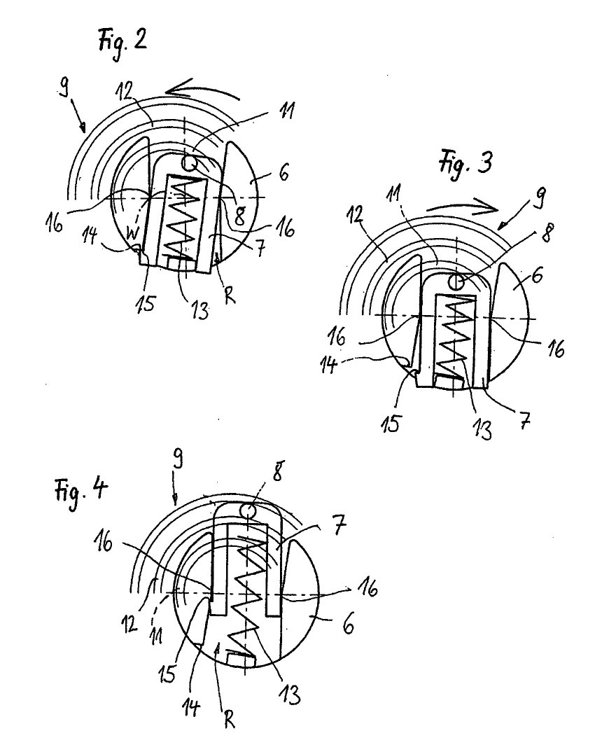

FIG. 2 shows, in a schematic sectional illustration, a control finger of a counting mechanism of the protection device according to FIG. 1 in a latching position on a winding shaft,

FIG. 3 shows the control finger on the winding shaft in a release position, and

FIG. 4 shows the control finger in a further position of movement within a spiral counting means of the counting mechanism.

A protection device illustrated in FIG. 1 constitutes a restraining device for loaded goods, which device can be stretched in a vehicle interior of a passenger vehicle between passenger compartment and loading compartment. The restraining device is suitable for all passenger vehicles in which the loading compartment merges in an open manner into the passenger compartment, in particular in the case of estate cars, vans or SUVs. In the exemplary embodiment illustrated, the restraining device has a flexible sheetlike structure in the form of a separating net 1 which is held on a winding shaft 4 in a manner such that it can be wound up and unwound. The separating net 1 is provided at its front end region 2 in the pull-out direction with a dimensionally stable pull-out strip which has holding heads 3 on opposite end sides. The holding heads 3 can be fitted into holding receptacles which are on the roof and are arranged such that they are fixed to the vehicle.

The winding shaft 4 is mounted rotatably about a winding shaft W in a cassette housing, which is not illustrated for reasons concerned with clarity. The cassette housing is positioned releasably and fixed to the vehicle in a basically known manner directly behind a single- or multi-part backrest arrangement of a rear seat bench. In this case, the cassette housing is usually arranged approximately level with a vehicle window-base edge and extends in the transverse direction of the vehicle between opposite side wall parts of the loading compartment.

A winding spring arrangement 5 acts on the winding shaft 4 in the winding-up direction of the separating net 1, so that the separating net automatically winds up, without a tensile loading in the unwinding direction, into its inoperative position, in which it is rolled up on the winding shaft 4. In the exemplary embodiment illustrated, the winding spring arrangement 5 is designed as a helical spring and is supported at one spring end against a stationary spindle profile oriented coaxially within the winding shaft 4, and at its other spring end against the inside of the winding shaft 4.

The restraining device according to FIG. 1 is provided with a counting mechanism 7 to 9 which is described below in more detail and interacts with part of a control mechanism for the displacement-dependent switching off of the winding-up force of the winding spring arrangement 5.

Control mechanisms of this type are furthermore known from WO 98/24660 A2, in particular from the embodiment there according to FIGS. 14 to 18, or from DE 100 56 671 C1. As an alternative to the embodiment described below, the control mechanism assigned to the winding shaft 4,according to FIG. 1 can be realized in accordance with one of the embodiments disclosed in the two publications. The winding-up force of the winding spring arrangement 5 is switched off or reduced there as a function of time and/or displacement.

The winding-up force of the winding spring arrangement 5 is preferably initially maintained for a certain pull-out distance of the separating net 1 from its wound-up inoperative position. For this first pull-out distance, the separating net 1 can firstly be pulled approximately horizontally to the rear from its wound-up inoperative position by means of an appropriate operator. This is an ergonomically favorable pulling movement for the operator, with the result that the operator can easily overcome the winding-up force of the winding spring arrangement 5. As soon as the operator pulls out the separating net 1 to a sufficient distance to the rear that it can be fitted into holders on the roof, the operator has to guide the separating net 1 upward in this pulled-out position from the rear and fit it into the retaining receptacles on the roof. If the pull-back force of the winding spring arrangement 5 was to continue to be fully effective for this operation too, the operator, in an ergonomically unfavorable position, would firstly have to compensate for this winding spring force by means of appropriate effort and, secondly, would simultaneously have to fit the holding heads 3 into the holding receptacles on the roof. In the case of the present embodiment according to FIGS. 1 to 4, which to this extent corresponds functionally and in terms of construction to a corresponding embodiment of the abovementioned publications, in order to avoid these unfavorable loadings, the control mechanism is activated, as a result of which the restoring force of the winding spring arrangement 5 is temporarily switched off or reduced. As already described with reference to the abovementioned publications, the switching off or reduction of the restoring force of the winding spring arrangement 5 takes place in a simple manner by the control mechanism of one of the two parts to which the different ends of the winding spring arrangement 5 are connected being activated in such a manner that either both parts rotate at the same time, or both parts are shut down. As a result, the winding spring arrangement is temporarily switched off. For this operation, the control mechanism has a control finger 7 which is arranged on a front end region 6 of the winding shaft 4 and has a corresponding guide pin 8 which engages in corresponding spiral turns of a spiral counting means 9. The spiral counting means 9 is part of the counting mechanism and is arranged in a stationary manner in the cassette housing. The spiral counting means 9 is arranged coaxially with the winding shaft 4 at the front end of the winding shaft 4 in such a manner that the control finger 7 is moved together with its guide pin 8 within the spiral turns of the spiral counting means 9 during a rotational movement of the winding shaft 4. The spiral counting means 9 is provided radially on the inside with a central passage 10 into which the spindle profile of the winding shaft 4 dips in the fitted state. The spiral turns of the spiral counting means 9 are formed by a guide web 11, 12, which is wound in a correspondingly spiral-shaped manner. A section 11 of the guide web, which section forms the radially innermost spiral turn, is arranged adjacent to the passage 10 and has a front edge at which the section 11 forming the inner spiral turn ends. The section 11 forming the innermost spiral turn merges flush into the next radially outer spiral turn 12 which in turn continues into correspondingly further spiral turns. In the region of a spiral turn situated relatively far radially outward, a stop A is provided against which the guide pin 8 of the control finger strikes. This prevents a further rotational movement of the winding shaft 4. With this means, the winding-up force of the winding spring arrangement 5 is also inevitably briefly stopped.

Radially outside the stop A, the spiral counting means 9 has a further control track S which is designed such that it revolves continuously. In the region of the stop A, the control track S is assigned an elastically movable control tongue Z which permits the guide pin 8 of the control finger 7 to be guided past in the pull-out direction of the separating net 1 and therefore in the unwinding direction of the winding shaft 4. By contrast, in the opposite direction, the control tongue Z serves as a catch or switch which deflects the guide pin 8 back again into the spiral track situated therebelow.

As can be seen with reference to FIGS. 2 to 4, the control finger 7 is arranged movably in a translatory manner radially with respect to the winding axis W in the front end region 6 of the winding shaft 4 in the direction of the double arrow (FIG. 1). The control finger 7 is spring-loaded radially outward by a compression spring 13. The control finger 7 is designed as a bow-like component which is provided with two U-shaped limbs between which the compression spring 13 is arranged. A radial guide R is provided within the front end region 6 of the winding shaft 4 and is open to opposite sides of the front end region 6 in a common radial plane. The radial guide R is provided with a constriction 16 approximately level with the winding axis W, so that, starting from the central constrictions 16, the radial guide R expands radially outward to both sides in the manner of a funnel. In this case, the side walls of the radial guide R, which side walls are situated opposite each other in an alternating point-symmetrical manner with respect to the winding axis W, are in each case formed parallel to each other. In addition, the distance between the side wall sections aligned parallel to each other in each case corresponds approximately to the width of the control finger 7. The two constrictions 16 are also at a distance from each other which approximately corresponds to the width of the control finger 7.

In addition, the control finger 7 has a latching lug 15, which serves as an undercut, in the region of its one limb. Corresponding to this latching lug 15, a profiled latching means 14 is provided on the adjacent side wall of the radial guide R and serves as the undercut assigned to the winding shaft. As can be seen with reference to FIGS. 2 to 4, the control finger 7 is either oriented in a position in which the latching lug 15 engages behind the profiled latching means 14 of the radial guide R, or the control finger 7 is tilted toward the opposite side wall in such a manner that the latching lug 15 comes free from the profiled latching means 14 of the winding shaft. In this release position, the control finger 7 can be pressed radially outward by the compressive force of the compression spring 13.

A latching lug 15 and the corresponding profiled latching means 14 are arranged in such a manner that the control finger 7, in its radially inner position, is inevitably tilted in the winding-up direction of the winding shaft in such a manner that the latching lug 15 engages behind the profiled latching means 14. The tiltability is obtained by means of the constrictions 16 which define pivotal points in the manner of a rocker. Since the guide pin 8 slides along the inner spiral guide section 11 of the spiral counting means 9, the corresponding frictional force brings about a torque on the control finger 7 counter to the direction of rotation of the winding shaft. As a result, the control finger 7, which is at the same time pressed radially outward by the compressive force of the compression spring 13, can engage behind the profiled latching means 14 by means of its latching lug 15. As soon as the direction of rotation of the winding shaft turns round and the winding shaft is therefore turned in the unwinding direction, the direction of the frictional force acting on the guide pin 8 of the control finger 7 in the region of the spiral guide section 11 also turns round. As a result, an opposed torque is applied to the control finger 7, with the result that the control finger 7 comes free with its latching lug 15 from the profiled latching means 14. The compression spring 13 can now be effective again and presses the control finger 7 radially outward, so that the latter gradually moves outward in the spiral turns in the unwinding direction of the winding shaft and therefore of the separating net. As soon as the control finger 7 and therefore the guide pin 8 have reached the stop A of the spiral incrementing means 9, a further rotational movement of the winding shaft 4 is blocked. The restoring force of the winding spring arrangement 5 then rotates the guide pin 8 and therefore subsequently the control finger 7 back slightly in the spiral incrementing means 9 until the guide pin 8 strikes against the counter stop G of the spiral incrementing means 9. The restoring force of the winding spring arrangement 5 is now inevitably disengaged. The compressive force of the compression spring 13 presses the control finger 7 radially outward along the counter stop G and the control tongue 2 until the guide pin 8 has arrived in the control track S. A further pull-out operation of the separating net 1 and therefore a further unwinding direction of the winding shaft 4 now lead to the guide pin 8 being able to circulate continuously—of course, restricted to the number of possible revolutions—in the control track S in the unwinding direction of the winding shaft 4. As soon as the holding heads 3 are fitted into the retaining receptacles on the roof, the restoring force of the winding spring arrangement 5 rotates the winding shaft 4 in the opposite direction of rotation and therefore in the winding-up direction. As a result, the guide pin 8 inevitably comes to stop against the control tongue Z, by means of which it is guided back via the counter stop G into the radially next inner spiral turn. During the subsequent winding-up operation, which is caused by the restoring force of the winding spring 5, the guide pin 8 is gradually moved inward again in the spiral turns, as a result of which the control finger 7 is simultaneously displaced radially inward. As soon as the guide pin 8 and therefore the control finger 7 have reached the inner spiral guide section 11, the latching lug 15 of the control pin 7 latches behind the profiled latching means 14, so that the compression spring 13 can no longer press the control pin 7 radially outward against the corresponding spiral guide section 12. Only when the direction of rotation is reversed again and the separating net 1 is unwound again from its inoperative position does the control finger 7 pass again into the position according to FIG. 3, so that a renewed pull-out operation with a corresponding radial movement of the control finger 7 in the direction of the position according to FIG. 4 begins.

The embodiment according to the invention is particularly advantageous if the guide pin 8 has already reached the radially inner spiral guide section 11 and nevertheless the winding shaft 4 still has to carry out a plurality of revolutions until the separating net 1 is transferred into its inoperative position. This is because this avoids the guide pin 8 and the control finger 7 sliding beyond the front edge of the spiral guide section 11 during each revolution and in the process the guide pin 8 striking against the next, radially outer spiral guide section 12 because of the compressive force of the compression spring 13. The guide pin 8 protrudes from the control finger 7 in an axially parallel manner to the winding axis W and is guided in the spiral guide of the spiral incrementing means 9, which is oriented in a radial plane with respect to the winding axis W.

As can be seen with reference to the illustrations according to FIGS. 2 to 4, an upper side wall section of the left side wall above the left constriction 16 is oriented parallel to a vertical. In the same manner, a lower side wall section of the right side wall of the radial guide R, which section is arranged below the right constriction 16, is oriented parallel to the vertical. By contrast, the two remaining side wall sections of the opposite side walls are oriented parallel to each other but at an angle with respect to the vertical.

1. Protection device for a motor vehicle with a flexible sheetlike structure (1) which is arranged on a winding shaft (4), which is mounted rotatably in a housing, in a manner such that it can be wound up and unwound between a wound-up inoperative position and at least one at least partially extended protection position, the winding shaft (4) being acted upon by torque in the winding-up direction by means of a winding spring arrangement (5), the winding-up force of which can be reduced by means of a control mechanism (6 to 9), the control mechanism (6 to 9) comprising a spiral counting means (9) and a control finger (7, 8), which is guided in the spiral counting means (9), is movable radially relative to a winding axis (W) of the winding shaft (4) and is pressed, at least in the unwinding direction, by spring force against a guide web (11, 12), which has a spiral-shaped profile, of the spiral counting means (9), characterized in that the control finger (7, 8) is assigned securing means (14, 15) which hold the control finger (7, 8) back in an inner position in the winding-up direction of the sheetlike structure (1).

2. Protection device according to claim 1, characterized in that the control finger (7, 8) is guided in a radially movable manner in a radial guide (R) assigned to the winding shaft, and in that the securing means (14, 15) are designed as mutually corresponding undercuts (14, 15), which are effective with a form fit, in the region of the radial guide (R), on the one hand, and in the region of the control finger (7, 8), on the other hand.

3. Protection device according to claim 2, characterized in that the radial guide (R) is designed in such a manner that the control finger (7, 8) can carry out limited tilting movements about a tilting axis running coaxially or parallel to the winding axis (W).

4. Protection device according to claim 1, characterized in that the control finger (7, 8) is spring-loaded radially outward—with respect to the winding axis (W).

5. Protection device according to claim 2, characterized in that the undercuts (14, 15) of the radial guide (R) and of the control finger (7, 8) are arranged on an individual, common side which is selected in such a manner that the undercuts engage one behind the other in the winding-up direction of the winding shaft (W) and are separated from each other in the unwinding direction.

6. Protection device according to claim 2, characterized in that the radial guide is constricted level with the winding axis (W) and from there is expanded radially outward to opposite sides in the manner of a funnel.
